(19) United States
(12) Patent Application Publication
(10) Pub. No.: US 2013/0114134 A1
(43) Pub. Date: May 9, 2013

(54) DISPLAY DEVICE AND ELECTRONIC APPARATUS

(71) Applicant: SONY CORPORATION, Tokyo (JP)

(72) Inventors: Yuichi Inoue, Kanagawa (JP); Mariko Obinata, Kanagawa (JP); Norifumi Hoshino, Tokyo (JP)

(73) Assignee: SONY CORPORATION, Tokyo (JP)

(21) Appl. No.: 13/660,240

(22) Filed: Oct. 25, 2012

(30) Foreign Application Priority Data
Nov. 7, 2011 (JP) 2011-243449

(51) Int. Cl. G02B 27/22

(52) U.S. Cl. 359/462

(57) ABSTRACT

A display device includes: a display section including a plurality of pixels, the display section displaying a plurality of perspective images; and a plurality of separating sections each tilted in a first oblique direction, and each separating the perspective images displayed on the display section into different directions. Each of the pixels has a shape extending differently between in the first oblique direction and in a second oblique direction, the second oblique direction being tilted in a direction opposite to the first oblique direction with respect to a vertical direction.

### BACKGROUND

This disclosure relates to a display device that performs stereoscopic display of a naked-eye scheme with use of a parallax barrier and the like, and to an electronic apparatus that includes such a display device.

Methods performing stereoscopic display include an eyeglasses scheme that uses eyeglasses for stereoscopic vision and a naked-eye scheme that achieves stereoscopic vision with naked eyes without using the special eyeglasses for stereoscopic vision. Typical methods of the naked-eye scheme are a parallax barrier scheme and a lenticular lens scheme. In the parallax barrier scheme and the lenticular lens scheme, a plurality of perspective images (perspective images for respective right and left eyes, in a case of two perspectives) for stereoscopic vision are displayed space-divisionally on a two-dimensional display panel, and the displayed perspective images are separated in a horizontal direction by a separator. Thus, a stereoscopic vision is achieved. In the parallax barrier scheme, a parallax barrier that includes slit-like opening sections is used as the separator. In the lenticular lens scheme, a lenticular lens that includes a plurality of cylindrical lens elements arranged side-by-side is used as the separator.

Further, a configuration is known in which the opening sections of the parallax barrier scheme are tilted in an oblique direction, or in which the cylindrical lens elements in the lenticular lens scheme are tilted in an oblique direction (see Japanese Unexamined Patent Application Publication (Translation of PCT Application) No. 2001-501073).

### SUMMARY

In the case of the above-described configuration in which the opening sections or the lens elements are tilted in an oblique direction, moire may occur depending on a relationship between the opening sections (or the lens elements) and factors including a pixel arrangement, a shape of pixels, etc. This may lead to degradation in quality of stereoscopic display.

It is desirable to provide a display device and an electronic apparatus that are capable of suppressing occurrence of moire in stereoscopic display.

According to an embodiment of the present disclosure, there is provided a display device including: a display section including a plurality of pixels, the display section displaying a plurality of perspective images; and a plurality of separating sections each tilted in a first oblique direction, and each separating the perspective images displayed on the display section into different directions. Each of the pixels has a shape extending differently between in the first oblique direction and in a second oblique direction, the second oblique direction being tilted in a direction opposite to the first oblique direction with respect to a vertical direction.

According to an embodiment of the present disclosure, there is provided an electronic apparatus with a display device, the display device including: a display section including a plurality of pixels, the display section displaying a plurality of perspective images; and a plurality of separating sections each tilted in a first oblique direction, and each separating the perspective images displayed on the display section into different directions. Each of the pixels has a shape extending differently between in the first oblique direction and in a second oblique direction, the second oblique direction being tilted in a direction opposite to the first oblique direction with respect to a vertical direction.

It is to be noted that, in the display device and the electronic apparatus according to the embodiments of the present disclosure, “pixel” may include a plurality of sub-pixels. In this case, “shape” described above may correspond to a shape of each of the sub-pixels.

In the display device and the electronic apparatus according to the embodiments of the present disclosure, the plurality of perspective images displayed on the display section are separated into different directions by the plurality of separating sections. Each of the separating sections is tilted in the first oblique direction, and each of the pixels has a shape that extends differently between in the first oblique direction and in the second oblique direction when the second oblique direction is tilted in a direction opposite to the first oblique direction with respect to the vertical direction. Therefore, occurrence of moire is suppressed.

According to the display device and the electronic apparatus according to the embodiments of the present disclosure, each of the separating sections is tilted in the first oblique direction, and each of the pixels has a shape that extends differently between in the first oblique direction and in the second oblique direction when the second oblique direction is tilted in a direction opposite to the first direction with respect to the vertical direction. Therefore, it is possible to suppress occurrence of moire in stereoscopic display.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a cross-sectional view illustrating an example of a general configuration of a display device according to a first embodiment of the present disclosure.

FIG. 2 is a plan view illustrating a first example of a pixel arrangement in a display section and of a configuration of a parallax barrier in the display device according to the first embodiment.

FIG. 3 is a plan view illustrating a second example of the pixel arrangement in the display section and of the configuration of the parallax barrier.

FIG. 4 is a plan view illustrating a third example of the pixel arrangement in the display section and of the configuration of the parallax barrier.

FIG. 5 is a plan view illustrating a pixel structure and a configuration of a parallax barrier according to a comparative example.

FIG. 6 is a characteristic diagram illustrating a ratio of a transmission area of a sub-pixel that is transmitted through an opening section of the parallax barrier, in the pixel structure shown in FIG. 5.

FIG. 7 is a plan view illustrating a specific example of the pixel structure and of the configuration of the parallax barrier according to the comparative example.

FIG. 8 is a characteristic diagram illustrating an ideal example of the ratio of the transmission area of the sub-pixel that is transmitted through the opening section of the parallax barrier.

FIGS. 9A and 9B are plan views illustrating a first example of a pixel shape that improves moire.

FIG. 10 is a plan view illustrating an example of a pixel arrangement to which the pixel shape shown in FIGS. 9A and 9B is applied.

FIGS. 11A and 11B are plan views illustrating a second example of the pixel shape that improves moire.

FIG. 12 is a plan view illustrating an example of a pixel arrangement to which the pixel shape shown in FIGS. 11A and 11B is applied.

FIGS. 13A and 13B are plan views illustrating a third example of the pixel shape that improves moire.

FIG. 14 is a plan view illustrating an example of a pixel arrangement to which the pixel shape shown in FIGS. 13A and 13B is applied.

FIG. 15 is a plan view illustrating an example of a pixel arrangement in which the pixel shapes shown in FIGS. 9A and 9B and in FIGS. 13A and 13B are used in combination.

FIGS. 16A and 16B are plan views illustrating an example of a multi-pixel structure according to another comparative example.

FIGS. 17A and 17B are plan views illustrating a first example of a pixel shape that improves moire in the multi-pixel structure.

FIG. 18 is a plan view for explaining features of the pixel shape shown in FIG. 17B.

FIGS. 19A and 19B are plan views illustrating a second example of the pixel shape that improves moire in the multi-pixel structure.

FIG. 20 is a plan view for explaining features of the pixel shape shown in FIG. 19B.

FIG. 21 is a cross-sectional view illustrating another configuration example of the display device.

FIG. 22 is an appearance diagram illustrating an example of an electronic apparatus.

### DETAILED DESCRIPTION

Hereinafter, embodiments of the present disclosure will be described in detail with reference to the drawings. The description will be given in the following order.

### 1. First Embodiment

An example of a display device of a parallax barrier scheme

### 2. Second Embodiment

An example using a multi-pixel structure

### 3. Third Embodiment

An example of a display device of a lenticular lens scheme

### 4. Other Embodiments

An example of an electronic apparatus and the like

### 1. First Embodiment

### Basic Configuration of Display Device

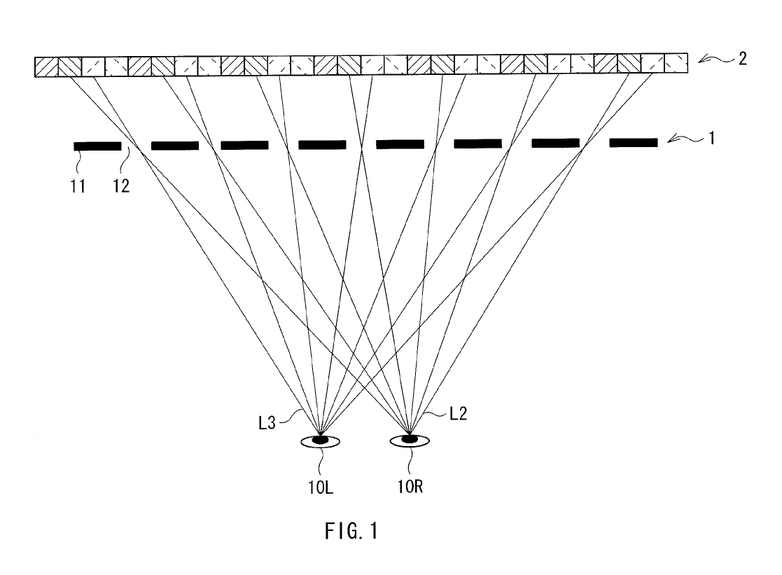

Description will be given of a basic configuration of a display device according to a first embodiment of the present disclosure with reference to FIGS. 1 to 4. The display device includes a parallax barrier 1 and a display section 2.

The display section 2 is configured of a two-dimensional display such as a liquid crystal display panel, a display panel of an electroluminescence scheme, and a plasma display. The display section 2 includes a plurality of pixels that are arranged two-dimensionally in a horizontal direction and in a vertical direction in an image display surface thereof. Each of the pixels includes a plurality of sub-pixels.

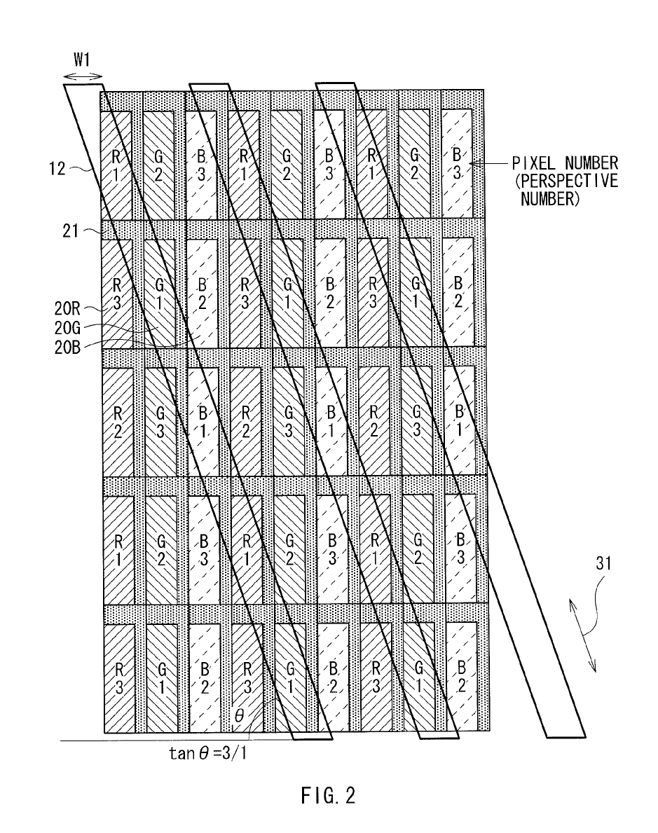

For example, as shown in FIGS. 2 to 4, each pixel includes sub-pixels of first to third colors that may be a R (red) sub-pixel 20R, a G (green) sub-pixel 20G, and a B (blue) sub-pixel 20B. Further, sub-pixels of the three colors are alternately arranged in a cycle in the horizontal direction, and sub-pixels of the same color are arranged in the vertical direction. Further, a black matrix 21 is provided between the sub-pixels. Hereinafter, a term “sub-pixel 20” will be used to collectively refer to sub-pixels of the first to third colors without distinguishing the sub-pixels based on colors. The display section 2 synthesizes and displays parallax images (perspective images) for a plurality of perspectives that are allocated to respective sub-pixels 20 according to a predetermined pattern.

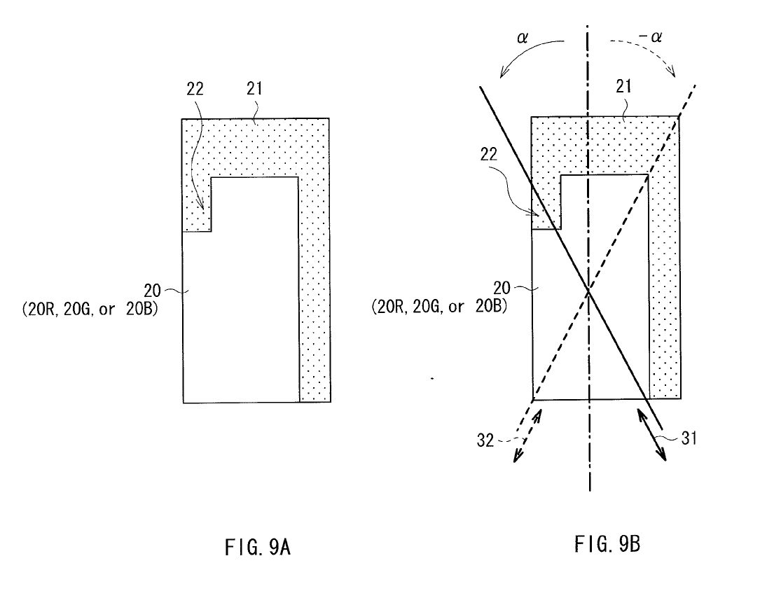

It is to be noted that a shape of the sub-pixel 20 is illustrated simply as a rectangular shape in FIGS. 2 to 4 for the sake of explaining mainly the arrangement state of the pixels of the pixel configuration. However, more specifically, the sub-pixel 20 has a shape including a notch in part thereof to improve moire as described later with reference to FIGS. 9A and 9B, etc.

The parallax barrier 1 so separates, in a plurality of perspective directions, the plurality of perspective images included in the synthesized parallax image displayed on the display section 2 as to achieve stereoscopic vision. The parallax barrier 1 is so arranged to face the display section 2 in a predetermined positional relationship as to achieve stereoscopic vision. The parallax barrier 1 includes a shielding section 11 that blocks light and an opening section 12 that transmits light. The parallax barrier 1 may be a fixed barrier device or may be a variable barrier device. When the parallax barrier 1 is a fixed barrier device, such a parallax barrier may be used in which a pattern serving as the opening section 12 and the shielding section 11 is formed using a material such as thin-film metal on a surface of a member such as a transparent parallel flat plate (base material). When the parallax barrier 1 is a variable barrier device, the pattern serving as the opening section 12 and the shielding section 11 may be formed selectively by, for example, a display function (light modulation function) of a liquid crystal display element of a backlight scheme. It is to be noted that FIG. 1 illustrates an example where the parallax barrier 1 is arranged on the display surface side of the display section 2. However, a configuration may be employed in which the parallax barrier 1 is arranged on the back face side of the display section 2. For example, when a liquid crystal display panel of a backlight scheme is used as the display section 2, the parallax barrier 1 may be arranged between a backlight and the liquid crystal display panel, on the back face side of the liquid crystal display panel.

The opening section 12 of the parallax barrier 1 functions as a separating section that separates the plurality of perspective images included in the synthesized parallax image on the screen of the display section 2 such that only a specific perspective image is viewed when the display section 2 is viewed from a specific perspective position. The positional relationship between the opening section 12 and each sub-pixel 20 in the display section 2 limits an emission angle of light emitted from each sub-pixel 20 in the display section 2. The direction in which each sub-pixel 20 in the display section 2 is displayed varies depending on the positional relationship between the sub-pixel 20 and the opening section 12. As illustrated in FIG. 1, a left eye 10L and a right eye 10R of a viewer receive a light beam L3 and a light beam L2 from different sub-pixels 20, respectively, and view perspective images having a parallax therebetween, thereby perceiving the perspective images as a stereoscopic image.

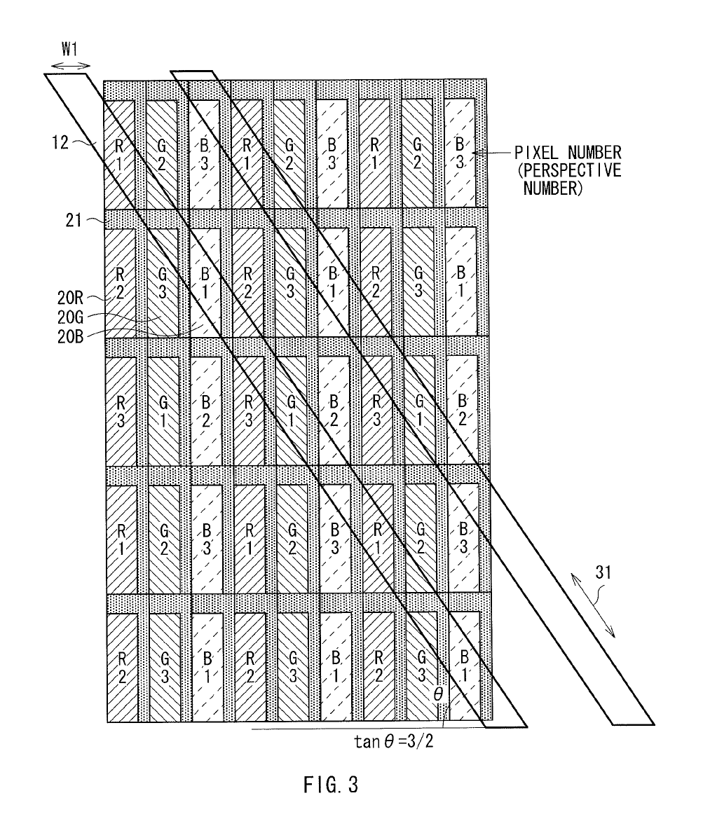

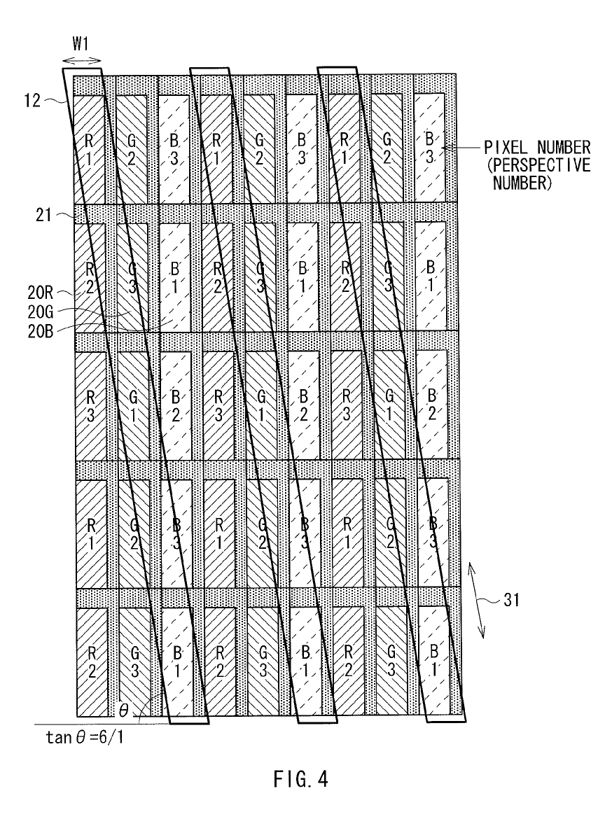

The opening section 12 of the parallax barrier 1 is tilted with respect to the vertical direction to extend in a first oblique direction 31, for example, as shown in FIGS. 2 to 4. Here, FIG. 2 illustrates an example where the opening section 12 is so tilted that tan θ is 3/1, where θ is an angle made by the opening section 12 with respect to the horizontal direction. FIG. 3 illustrates an example where the opening section 12 is so tilted that tan θ is 3/2. FIG. 4 illustrates an example where the opening section 12 is so tilted that tan θ is 6/1. It is to be noted that the number attached to each of the red sub-pixels 20R, the green sub-pixels 20G, and the blue sub-pixels 20B indicates a pixel number (perspective number) corresponding to the number of perspectives to be displayed. A case where the number of perspectives is three is illustrated here. Further, FIGS. 2 to 4 illustrate a state of an arrangement pattern (barrier pattern) of the opening sections 12 when viewed from a position corresponding to a first perspective image. The plurality of perspective images are allocated to the red sub-pixels 20R, the green sub-pixels 20G, and the blue sub-pixels 20B in a predetermined allocation pattern according to the tilt angle of the opening section 12, as shown in FIGS. 2 to 4.

### [Description on Occurrence of Moire]

In the configuration shown in FIGS. 1 to 4, the relative relationship between the position of the opening section 12 and the position of the sub-pixel 20 apparently varies according to a factor such as the perspective position of a viewer and the position (such as middle part and peripheral part) in the screen to be viewed by a viewer. Hence, the position, a region, etc. of the sub-pixel 20 to be viewed through the opening section 12 vary. Therefore, moire occurs disadvantageously in some pixel structures.

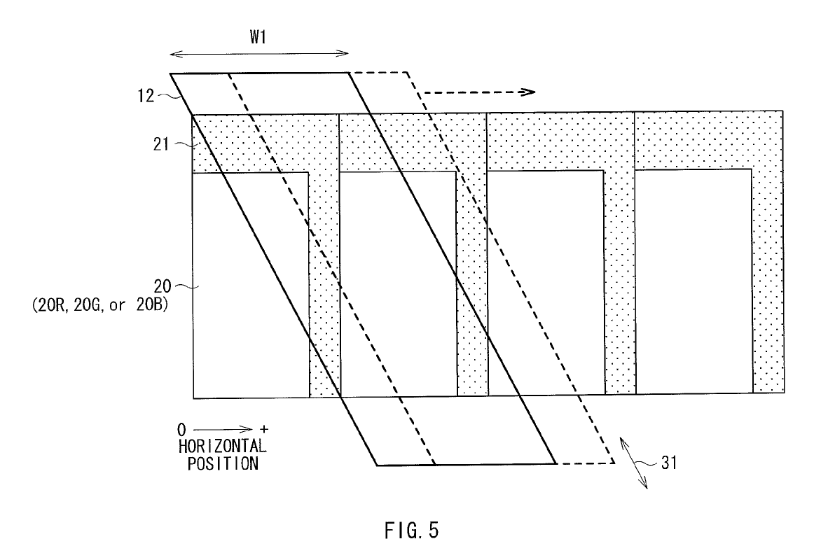

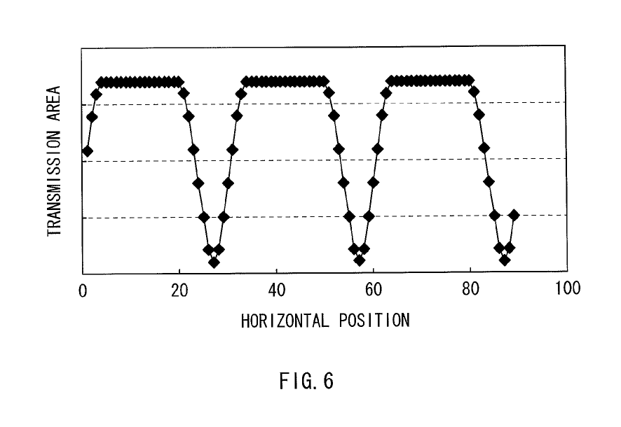

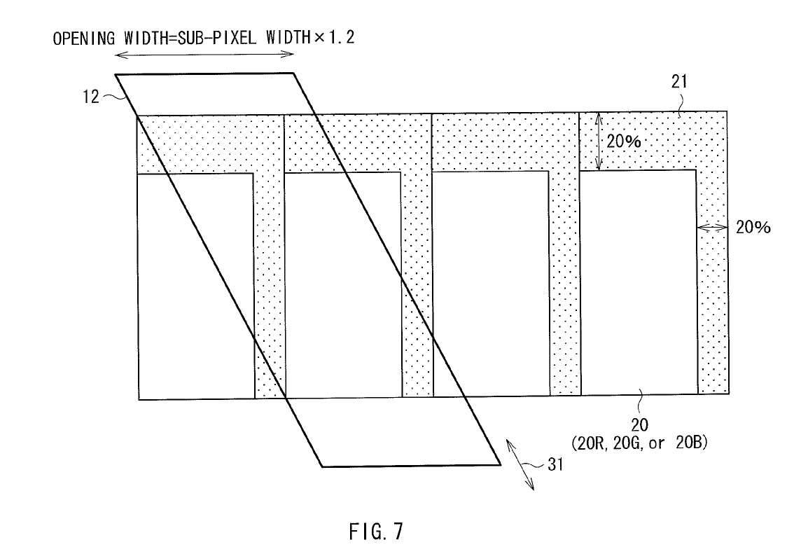

This will be explained with reference to an example where the sub-pixel 20 has a rectangular shape, as in a pixel configuration according to a comparative example illustrated in FIG. 5, for example. It is to be noted that FIG. 5 illustrates only four sub-pixels 20 in the horizontal direction, of all the sub-pixels 20. A ratio of light transmitted through the opening section 12 varies when the relative relationship between the position of the opening section 12 and the position of the sub-pixel 20 varies, since the black matrix 21 is provided between adjacent sub-pixels 20. The ratio of the light transmitted through the opening section 12 also varies according to an opening width W1. FIG. 6 illustrates an example of a calculation result of a ratio of transmission area of the sub-pixel 20 observed through the opening section 12 when the opening section 12 shifts in the horizontal direction from a left end position, which is a reference position, of the pixel column in FIG. 5. The ratio of the transmission area of the sub-pixel 20 varies as shown in the calculation example in FIG. 6, and therefore, the ratio of the transmitted light varies. This is perceived as a variation in luminance (moire). More specifically, modulation degree of luminance is 3.9% when the calculation for one sub-pixel 20 is performed under the conditions where a ratio of the black matrix 21 is 20% in the vertical and horizontal directions, the opening width W1 is 1.2 as large as a pixel width, and white display is performed on the whole screen, as shown in FIG. 7, for example. The modulation degree is calculated here by dividing a difference between the maximum value and the minimum value of luminance by an average value of luminance.

### [Example of Pixel Configuration Suppressing Occurrence of Moire]

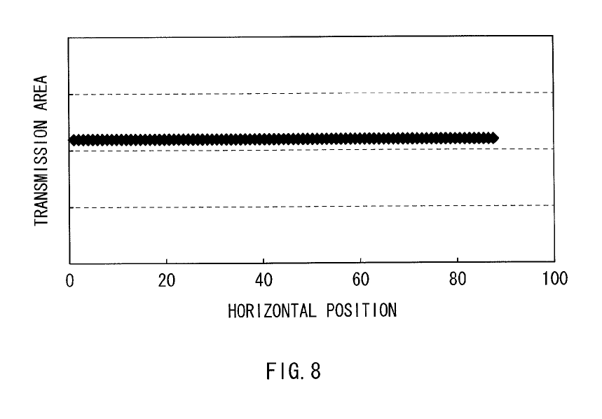

To suppress the occurrence of moire in the comparative example shown in FIG. 6, the ratio of the transmission area of the sub-pixel 20 may be made constant irrespective of the horizontal position of the opening section 12 as illustrated in FIG. 8. Description will be given of an example of a pixel structure that suppresses the occurrence of moire with reference to FIGS. 9A to 15. In each example described below, the opening section 12 of the parallax barrier 1 is tilted in the first oblique direction 31 at a first angle α (see FIG. 9B etc.) with respect to the vertical direction.

### First Example

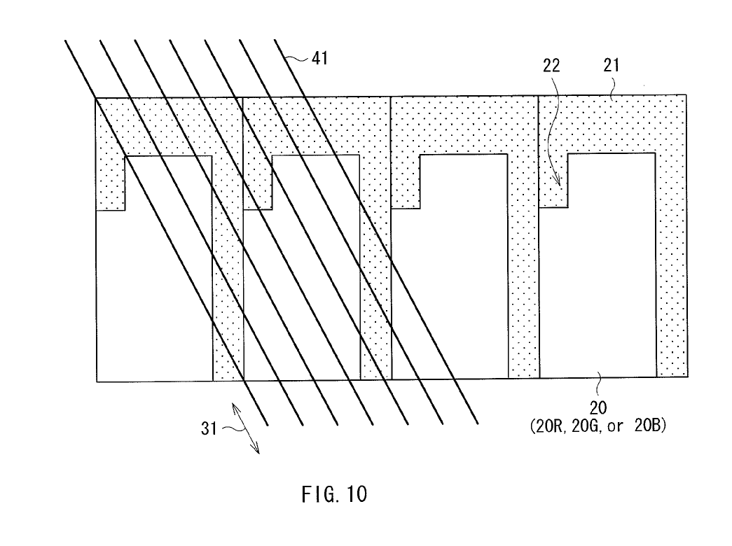

FIGS. 9A and 9B illustrate a first example of a pixel shape by which moire is improved. FIG. 10 illustrates an example of a pixel arrangement to which the pixel shape shown in FIGS. 9A and 9B is applied. It is to be noted that FIG. 10 illustrates only four sub-pixels 20 in the horizontal direction, of all the sub-pixels 20.

In this first example, the sub-pixel 20 has a shape that is substantially rectangular as a whole, and has one notch 22 in the first oblique direction 31. More specifically, the sub-pixel 20 has a shape obtained by cutting a smaller rectangular shape out of an upper-left corner of a larger rectangular shape. Therefore, the sub-pixel 20 has a shape that extends differently between in the first oblique direction 31 and in the second oblique direction 32 when the second oblique direction 32 is tilted in a direction opposite to the first oblique direction with respect to the vertical direction. The second oblique direction 32 is a direction that is tilted at a second angle −α as illustrated in FIG. 9B. The second angle −α and the first angle α are symmetric with respect to the vertical direction. The notch 22 may be a component of the black matrix 21. The notch 22 may be a component such as a thin film transistor (TFT) for driving a pixel and a photo spacer (PS).

### Second Example

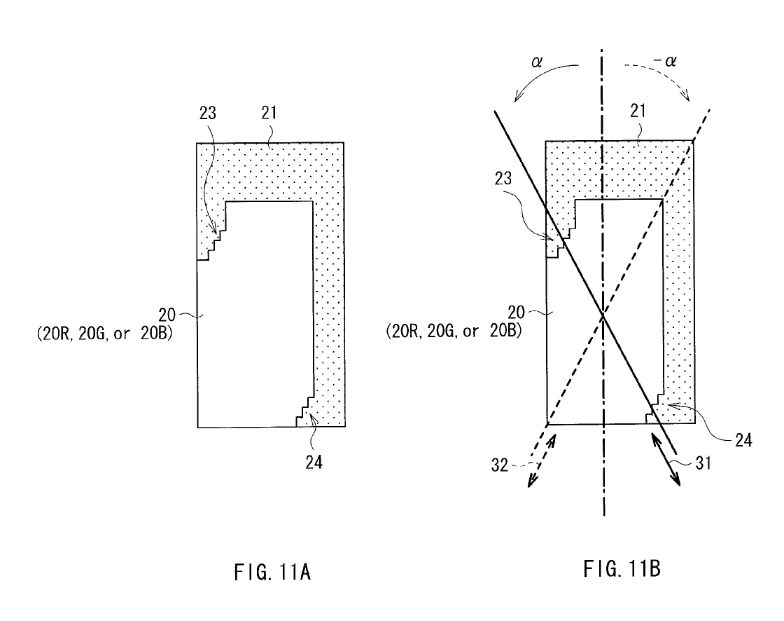

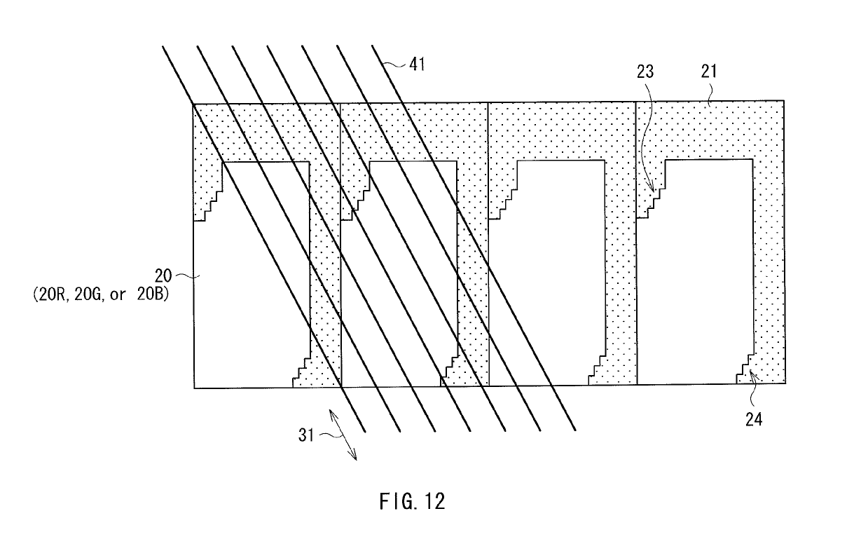

FIGS. 11A and 11B illustrate a second example of the pixel shape by which moire is improved. FIG. 12 illustrates an example of a pixel arrangement to which the pixel shape shown in FIGS. 11A and 11B is applied. It is to be noted that FIG. 12 illustrates only four sub-pixels 20 in the horizontal direction, out of all the sub-pixels 20.

In this second example, the sub-pixel 20 has a shape that is substantially rectangular as a whole and has a first notch 23 and a second notch 24 in the first oblique direction 31. Therefore, the sub-pixel 20 has a shape that extends differently between in the first oblique direction 31 and in the second oblique direction 32 when the second oblique direction 32 is tilted in a direction opposite to the first oblique direction 31 with respect to the vertical direction. More specifically, the sub-pixel 20 has a shape obtained by partially cutting out an upper-left corner of the rectangular shape in the second oblique direction 32. In addition thereto, the bottom-right corner of the rectangular shape is also partially cut out in the second oblique direction 32. It is to be noted that the first notch 23 and the second notch 24 may each have a shape cut out linearly in the second oblique direction 32, although FIGS. 11A to 12 illustrate an example where the first notch 23 and the second notch 24 each have a shape obliquely cut out in a step-like shape in the oblique direction. The first notch 23 and the second notch 24 each may be a component of the black matrix 21.

### Third Example

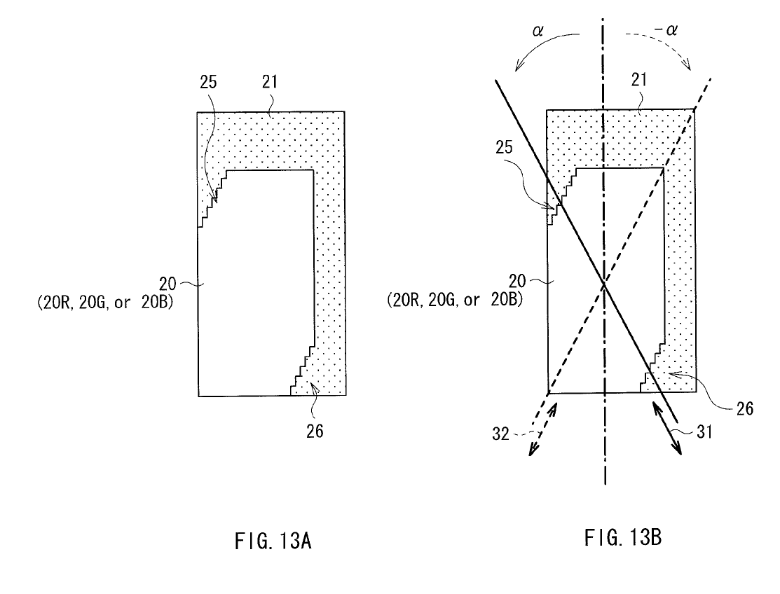

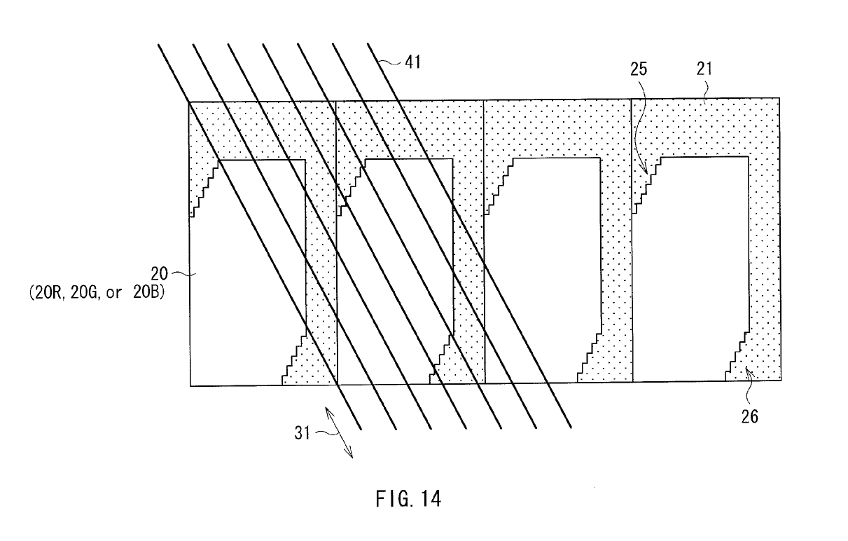

FIGS. 13A and 13B illustrate a third example of the pixel shape by which moire is improved. FIG. 14 illustrates an example of a pixel arrangement to which the pixel shape shown in FIGS. 13A and 13B is applied. It is to be noted that FIG. 14 illustrates only four sub-pixels 20 in the horizontal direction, out of all the sub-pixels 20.

In this third example, the sub-pixel 20 has a shape that is substantially rectangular as a whole and has a first notch 25 and a second notch 26 in the first oblique direction 31. Therefore, the sub-pixel 20 has a shape that extends differently between in the first oblique direction 31 and in the second oblique direction 32 when the second oblique direction 32 is tilted in a direction opposite to the first oblique direction 31 with respect to the vertical direction. More specifically, the sub-pixel 20 has a shape obtained by cutting out an upper-left corner and a bottom-right corner of the rectangular shape in the second oblique direction 32. It is to be noted that the first notch 25 and the second notch 26 may each have a shape cut out linearly in the second oblique direction 32, although FIGS. 13A to 14 illustrate an example where the first notch 25 and the second notch 26 each have a shape obliquely cut out in a step-like shape in the oblique direction. It is to be noted that a ratio of the first notch 25 and a ratio of the second notch 26 are substantially the same in this third example, although the ratio of the first notch 23 and the ratio of the second notch 24 are different from each other in the above-described second example. The first notch 25 and the second notch 26 each may be a component of the black matrix 21.

### Fourth Example

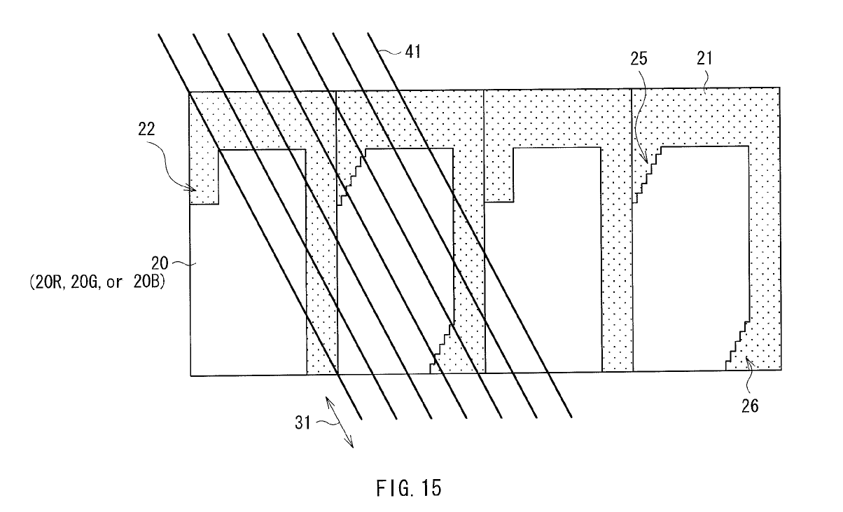

FIG. 15 illustrates a fourth example of the pixel shape by which moire is improved. It is to be noted that FIG. 15 illustrates only four sub-pixels 20 in the horizontal direction, out of all the sub-pixels 20. This fourth example is a combination of the pixel shape of the first example shown in FIGS. 9A and 9B and the pixel shape of the third example shown in FIGS. 13A and 13B. In this fourth example, sub-pixels 20 each having either of two different shapes are alternately arranged in the horizontal direction.

When providing the configuration of any of the above-described first to fourth examples, a ratio of an effective region of the sub-pixel 20 that is included in the parallel line 41, which is parallel to the tilt direction (the first oblique direction 31) of the opening section 12, becomes constant in a pixel column in the horizontal direction, irrespective of the position in the horizontal direction (see FIGS. 10, 12, 14, and 15). In other words, a ratio of a sum in length of line segment included in the parallel line 41 that just cross an effective region of each of one or more sub-pixels 20 becomes constant in the pixel column in the horizontal direction, irrespective of the position in the horizontal direction. It is to be noted that the effective region of the sub-pixel 20 refers to an effective light emitting region that substantially contributes to display, when the display section 2 is a self-light-emitting display, for example. Also, the effective region of the sub-pixel 20 refers to an effective pixel opening or an effective transmission region of light that substantially contributes to display, when the display section 2 is a liquid crystal display, for example. Accordingly, when the opening width W1 of the opening section 12 is the same, the ratio of the transmission area of the sub-pixel 20 is constant irrespective of the horizontal position of the opening section 12, and therefore, occurrence of moire is suppressed.

### [Effects]

As described above, according to the display device of the present embodiment, the opening section 12 as the separating section is tilted in the first oblique direction 31, and the sub-pixel 20 has a shape that extends differently between in the first oblique direction 31 and in the second oblique direction 32 when the second oblique direction 32 is tilted in a direction opposite to the first oblique direction 31 with respect to the vertical direction. Therefore, occurrence of moire in stereoscopic display is suppressed.

### 2. Second Embodiment

Next, description will be given of a display device according to a second embodiment of the present disclosure. It is to be noted that like numerals are used to designate substantially like components of the display device according to the first embodiment, and the description thereof is appropriately omitted.

The present embodiment relates to a so-called multi-pixel structure in which a unit pixel is partitioned into a plurality of segment regions that are each controlled separately according to a gray scale.

### [Example of Multi-Pixel Structure According to Comparative Example]

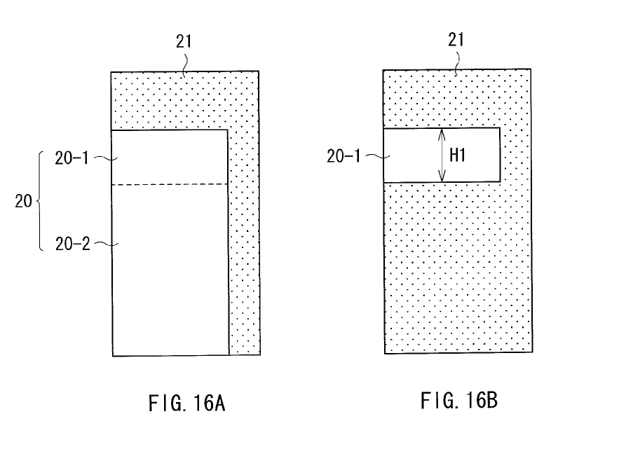

FIGS. 16A and 16B illustrates an example of a multi-pixel structure according to a comparative example. In this example of the multi-pixel structure, each of the sub-pixels 20 is partitioned into a first segment region 20-1 and a second segment region 20-2. Luminance of the first segment region 20-1 and luminance of the second segment region 20-2 are allowed to be controlled separately. Both of the first segment region 20-1 and the second segment region 20-2 are driven to have high luminance (white display) as shown in FIG. 16A, when white display is performed as a whole, for example. The first segment region 20-1 is driven to have high luminance (white display) and the second segment region 20-2 is driven to have low luminance (black display) as shown in FIG. 16B, when gray scale display (gray display) is performed as a whole, for example.

In the multi-pixel structure according to the comparative example shown in FIGS. 16A and 16B, the whole shape including the first segment region 20-1 and the second segment region 20-2 is a rectangular shape. Therefore, moire occurs as described with reference to FIGS. 5 to 7 when white display is performed as a whole. Further, in the multi-pixel structure according to the comparative example shown in FIGS. 16A and 16B, the first segment region 20-1 also has a rectangular shape and the pixel width in the vertical direction has a constant value of H1 irrespective of the horizontal position. Therefore, moire occurs by a principle similar to the above-described principle also when gray scale display is performed.

### [Example of Multi-Pixel Structure Suppressing Occurrence of Moire]

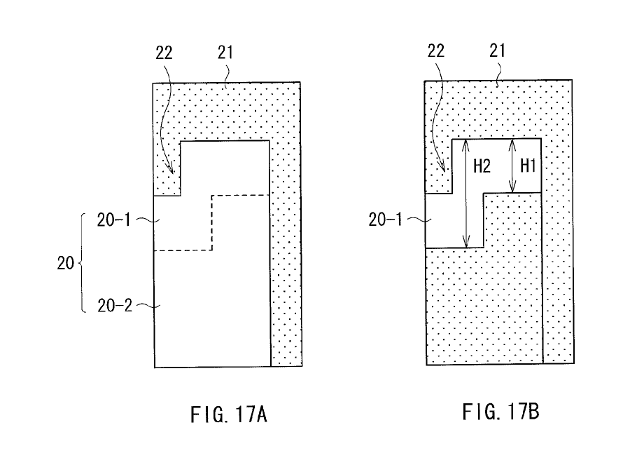

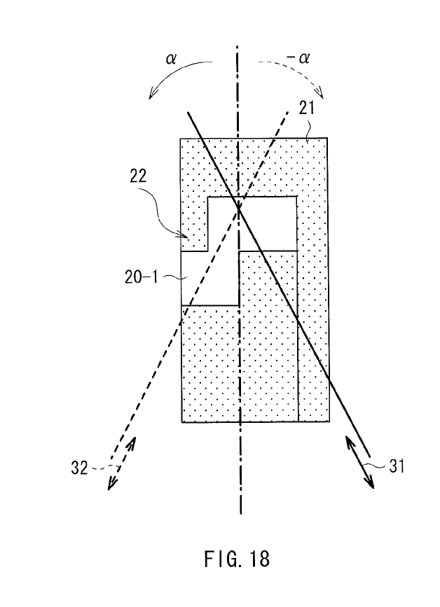

In comparison to the comparative example shown in FIGS. 16A and 16B, description will be given of an example of a pixel structure that suppresses the occurrence of moire in the both cases of performing white display and performing grayscale display with reference to FIGS. 17A to 20. In each example below, the opening section 12 of the parallax barrier 1 is tilted in the first oblique direction 31 at the first angle α (see FIG. 18, etc.) with respect to the vertical direction.

### First Example

FIGS. 17A, 17B, and 18 illustrate a first example of a pixel shape by which moire is improved in a multi-pixel structure. In the first example, as shown in FIG. 17A, the whole shape including the first segment region 20-1 and the second segment region 20-2 that configure the sub-pixel 20 is the same as the pixel shape described with reference to FIGS. 9A and 9B. In other words, the shape of the whole sub-pixel 20 is a shape that has one notch 22 in the first oblique direction 31, and that extends differently between in the first oblique direction 31 and in the second oblique direction 32 when the second oblique direction 32 is tilted in a direction opposite to the first oblique direction 31 with respect to the vertical direction. This suppresses occurrence of moire in performing white display.

Further, the first segment region 20-1 itself also has a shape that extends differently between in the first oblique direction 31 and in the second oblique direction 32, as shown in FIGS. 17B and 18. The pixel width of the first segment region 20-1 in the vertical direction varies as H1 and H2 according to the horizontal position, as illustrated in FIG. 17B. Also, the first segment region 20-1 has a part that extends in the second oblique direction 32, as shown in FIG. 18.

### Second Example

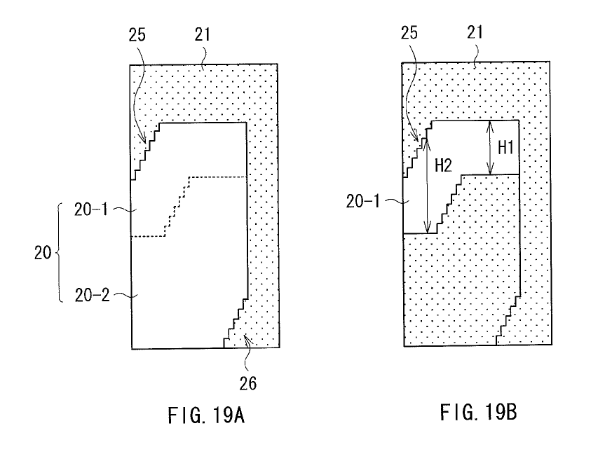

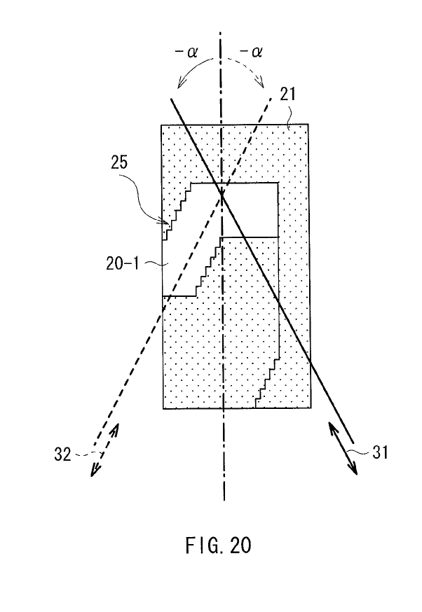

FIGS. 19A, 19B, and 20 illustrate a second example of the pixel shape by which moire is improved in the multi-pixel structure. In the second example, as shown in FIG. 19A, the whole shape including the first segment region 20-1 and the second segment region 20-2 that configure the sub-pixel 20 is the same as the pixel shape described with reference to FIGS. 13A and 13B. In other words, the shape of the whole sub-pixel 20 is a shape that has the first notch 25 and the second notch 26 in the first oblique direction 31, and that extends differently between in the first oblique direction 31 and in the second oblique direction 32 when the second oblique direction 32 is tilted in a direction opposite to the first oblique direction 31 with respect to the vertical direction. This suppresses occurrence of moire in performing white display.

Further, the first segment region 20-1 itself also has a shape that extends differently between in the first oblique direction 31 and in the second oblique direction 32, as shown in FIGS. 19B and 20. The pixel width of the first segment region 20-1 in the vertical direction varies as H1 and H2 according to the horizontal position, as illustrated in FIG. 19B. Also, the first segment region 20-1 has a part that extends in the second oblique direction 32, as shown in FIG. 20.

When providing the configuration of one of the above-described first and second examples, in both cases of performing white display and of performing grayscale display, the ratio of the effective region of the sub-pixel 20, that is included in the parallel line which is parallel to the tilt direction (the first oblique direction 31) of the opening section 12, becomes constant in the pixel column in the horizontal direction irrespective of the position in the horizontal direction. In other words, a ratio of a sum in length of line segment included in the parallel line that just cross an effective region of each of one or more sub-pixels 20 becomes constant in the pixel column in the horizontal direction, irrespective of the position in the horizontal direction. Accordingly, when the opening width W1 of the opening section 12 is the same, the ratio of the transmission area of the sub-pixel 20 is constant irrespective of the horizontal position of the opening section 12, and therefore, occurrence of moire is suppressed.

It is to be noted that the examples where the sub-pixel 20 is partitioned into two segment regions 20-1 and 20-2 is described above. However, the pixel may be partitioned into three or more regions.

### 3. Third Embodiment

Next, description will be given of a display device according to a third embodiment of the present disclosure. It is to be noted that like numerals are used to designate substantially like components of the display device according to the first and second embodiments, and the description thereof is appropriately omitted.

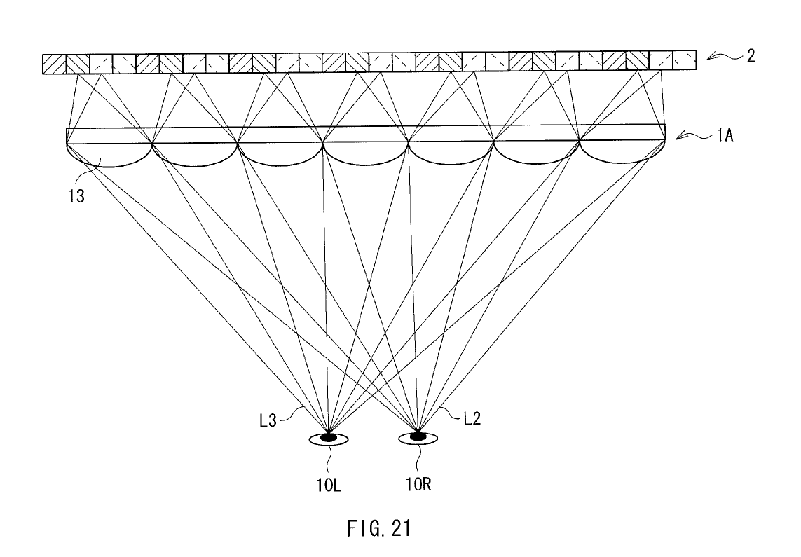

The display device of the parallax barrier scheme is described as an example in the first and the second embodiments. However, the technology of the present disclosure is applicable also to a display device of a lenticular lens scheme. For example, as shown in FIG. 21, a lenticular lens 1A may be used instead of the parallax barrier 1 shown in FIG. 1. The lenticular lens 1A includes a plurality of lens elements that function as a plurality of separating sections. The lens elements are each a cylindrical lens 13 that extends in a predetermined direction. The cylindrical lens 13 is so configured that a generatrix direction thereof is tilted in the first oblique direction 31 in a manner similar to that of the opening section 12 of the parallax barrier 1.

It is to be noted that a variable lenticular lens may be used as the lenticular lens 1A. As the variable lenticular lens, a lens such as liquid crystal lens and a liquid lens may be used.

### 4. Other Embodiments

The technology of the present disclosure is not limited to the above-described embodiments and may be variously modified.

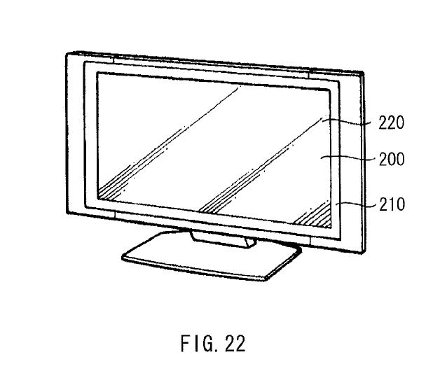

The display device according to any of the above-described embodiments is applicable to various electronic apparatuses that have a display function. FIG. 22 illustrates an appearance configuration of a television as an example of such an electronic apparatus. The television includes a image display screen section 200 that has a front panel 210 and a filter glass 220. The display device according to any of the above-described embodiments is also applicable to electronic apparatuses such as notebook personal computers, in addition to televisions.

It is possible to achieve at least the following configurations from the above-described example embodiments of the disclosure.

(1) A display device including:

a display section including a plurality of pixels, the display section displaying a plurality of perspective images; and

a plurality of separating sections each tilted in a first oblique direction, and each separating the perspective images displayed on the display section into different directions, wherein

each of the pixels has a shape extending differently between in the first oblique direction and in a second oblique direction, the second oblique direction being tilted in a direction opposite to the first oblique direction with respect to a vertical direction.

(2) The display device according to (1), wherein each of the pixels includes one or more notches in the first oblique direction.

(3) The display device according to (2), wherein each of the one or more notches has a rectangular shape.

(4) The display device according to (2), wherein each of the one or more notches has an oblique part tilted in the second oblique direction.

(5) The display device according to any one of (1) to (4), wherein

the pixels are arranged two-dimensionally in the vertical direction and in a horizontal direction, and

the separating sections are each tilted in the first oblique direction at a first angle with respect to the vertical direction.

(6) The display device according to (5), wherein a sum in length of line segments included in a parallel line parallel to the first oblique direction is substantially constant irrespective of a horizontal position of the parallel line, the parallel line crossing one or more pixels of a horizontal pixel line, and each of the line segments being a part just crossing an effective region of each pixel.

(7) The display device according to (5) or (6), wherein the second oblique direction is tilted at a second angle, the second angle and the first angle being symmetric with respect to the vertical direction.

(8) The display device according to any one of (1) to (7), wherein

each of the pixels is partitioned into a plurality of segment regions separately controlled according to gray scale, and

each of the pixels has, as a whole including all of the segment regions, a shape extending differently between in the first oblique direction and in the second oblique direction.

(9) The display device according to (8), wherein some of the plurality of segment regions also have shapes extending differently between in the first oblique direction and in the second oblique direction.

(10) The display device according to (9), wherein the segment region have a part extending in the second oblique direction.

(11) The display device according to any one of (1) to (9), wherein the display section includes a black matrix between the pixels.

(12) An electronic apparatus with a display device, the display device including:

a display section including a plurality of pixels, the display section displaying a plurality of perspective images; and

a plurality of separating sections each tilted in a first oblique direction, and each separating the perspective images displayed on the display section into different directions, wherein

each of the pixels has a shape extending differently between in the first oblique direction and in a second oblique direction, the second oblique direction being tilted in a direction opposite to the first oblique direction with respect to a vertical direction.

The present application contains subject matter related to that disclosed in Japanese Priority Patent Application JP 2011-243449 filed in the Japan Patent Office on Nov. 7, 2011, the entire content of which is hereby incorporated by reference.

It should be understood by those skilled in the art that various modifications, combinations, sub-combinations, and alterations may occur depending on design requirements and other factors insofar as they are within the scope of the appended claims or the equivalents thereof.

What is claimed is:

1. A display device comprising:
a display section including a plurality of pixels, the display section displaying a plurality of perspective images; and
a plurality of separating sections each tilted in a first oblique direction, and each separating the perspective images displayed on the display section into different directions, wherein
each of the pixels has a shape extending differently between in the first oblique direction and in a second oblique direction, the second oblique direction being tilted in a direction opposite to the first oblique direction with respect to a vertical direction.

2. The display device according to claim 1, wherein each of the pixels includes one or more notches in the first oblique direction.

3. The display device according to claim 2, wherein each of the one or more notches has a rectangular shape.

4. The display device according to claim 2, wherein each of the one or more notches has an oblique part tilted in the second oblique direction.

5. The display device according to claim 1, wherein
the pixels are arranged two-dimensionally in the vertical direction and in a horizontal direction, and
the separating sections are each tilted in the first oblique direction at a first angle with respect to the vertical direction.

6. The display device according to claim 5, wherein a sum in length of line segments included in a parallel line parallel to the first oblique direction is substantially constant irrespective of a horizontal position of the parallel line, the parallel line crossing one or more pixels of a horizontal pixel line, and each of the line segments being a part just crossing an effective region of each pixel.

7. The display device according to claim 5, wherein the second oblique direction is tilted at a second angle, the second angle and the first angle being symmetric with respect to the vertical direction.

8. The display device according to claim 1, wherein
each of the pixels is partitioned into a plurality of segment regions separately controlled according to gray scale, and
each of the pixels has, as a whole including all of the segment regions, a shape extending differently between in the first oblique direction and in the second oblique direction.

9. The display device according to claim 8, wherein some of the plurality of segment regions also have shapes extending differently between in the first oblique direction and in the second oblique direction.

10. The display device according to claim 9, wherein the segment region have a part extending in the second oblique direction.

11. The display device according to claim 1, wherein the display section includes a black matrix between the pixels.

12. An electronic apparatus with a display device, the display device comprising:
a display section including a plurality of pixels, the display section displaying a plurality of perspective images; and
a plurality of separating sections each tilted in a first oblique direction, and each separating the perspective images displayed on the display section into different directions, wherein
each of the pixels has a shape extending differently between in the first oblique direction and in a second oblique direction, the second oblique direction being tilted in a direction opposite to the first oblique direction with respect to a vertical direction.
